(19) United States
(12) Patent Application Publication
(10) Pub. No.: US 2007/0063824 A1
(43) Pub. Date: Mar. 22, 2007

(54) Vehicle warning system and detection apparatus

(76) Inventors: Kent B. Gaddy, Cave Springs, AR (US); Robert Dale Taylor II, Fayetteville, AR (US)

Correspondence Address: Raymond M. Galasso;Galasso & Associates LP, P.O. Box 26503, Austin, TX, 78755-0503, US

(21) Appl. No.: 11/207,403

(22) Filed: Aug. 18, 2005

(51) Int. Cl. B60R 25/10

(52) U.S. Cl. 340/426.21

(57) ABSTRACT

A vehicle warning system and detection apparatus are disclosed. In one form, a vehicle warning system includes a low-power radio frequency transmitter operable to transmit a warning signal identifying a hazardous driving condition. The system further includes a short-range radio frequency receiver mountable within an interior portion of a vehicle and operable to receive a warning signal transmitted from the low-power radio frequency transmitter and display operable to display a visual indication of the warning to alert an individual of the hazardous driving condition

### FIELD OF THE DISCLOSURE

The invention relates generally to warning system, and more particularly to a vehicle warning system and apparatus.

### BACKGROUND

Emergency medical services providers routinely respond to emergencies using lights and siren which require ambulances to be proximally located to a third party vehicle operator before being warned of a hazardous driving condition. This practice is not without risk of collision. Audible and visual warning devices and vehicle markings are integral to efficient negotiation of traffic and reduction of collision risk.

Motorists and pedestrians also represent the greatest threat to safe and efficient responses by emergency vehicles. Assuming pedestrians and drivers understand their responsibilities to yield to emergency vehicles, the primary objectives of warning systems are not always fulfilled. Conventional means of emergency vehicles providing audio and visual warnings fall short when localized sensory-based warning outputs are initiated for third parties to detect.

### BRIEF DESCRIPTION OF THE DRAWINGS

Other advantages, features and characteristics of the invention, as well as methods, operation and functions of related elements of structure, and the combinations of parts and economies of manufacture, will become apparent upon consideration of the following description and claims with reference to the accompanying drawings, all of which form a part of the specification, wherein like reference numerals designate corresponding parts in the various figures, and wherein:

FIG. 1 illustrates a block diagram of a vehicle warning system according to one embodiment of the invention;

FIG. 2 illustrates a device for detecting hazardous driving conditions according to one embodiment of the invention; and

FIG. 3 illustrates a functional block diagram of a device for detecting hazardous driving conditions according to one embodiment of the invention.

### DETAILED DESCRIPTION OF THE FIGURES

A vehicle warning system and detection device are disclosed. In one embodiment, an apparatus for detecting a hazardous driving condition is disclosed. The apparatus includes a short-range radio frequency communication module mountable within an interior portion of a vehicle and operable to receive a warning signal transmitted from an authorized road hazard transmitter wherein the warning signal identifies a hazardous driving condition. The apparatus further includes a display operable to provide a visual indication representing the received warning signal to alert an individual of the hazardous driving condition.

In another form, a vehicle warning system is disclosed and includes a low-power radio frequency transmitter operable to transmit a warning signal identifying a hazardous driving condition. The system further includes a short-range radio frequency receiver mountable within an interior portion of a vehicle and operable to receive a warning signal transmitted from the low-power radio frequency transmitter. The system further includes a display operable to display a visual indication of the warning to alert an individual of the hazardous driving condition.

In a further embodiment, an apparatus for detecting a hazardous driving condition includes a low power radio frequency transceiver operable to detect communication of a warning signal communicated within less than a one-mile radius. The apparatus further includes a display operable to display visual information indicating a type of road hazard associated with the warning signal that may be encountered within the one-mile radius.

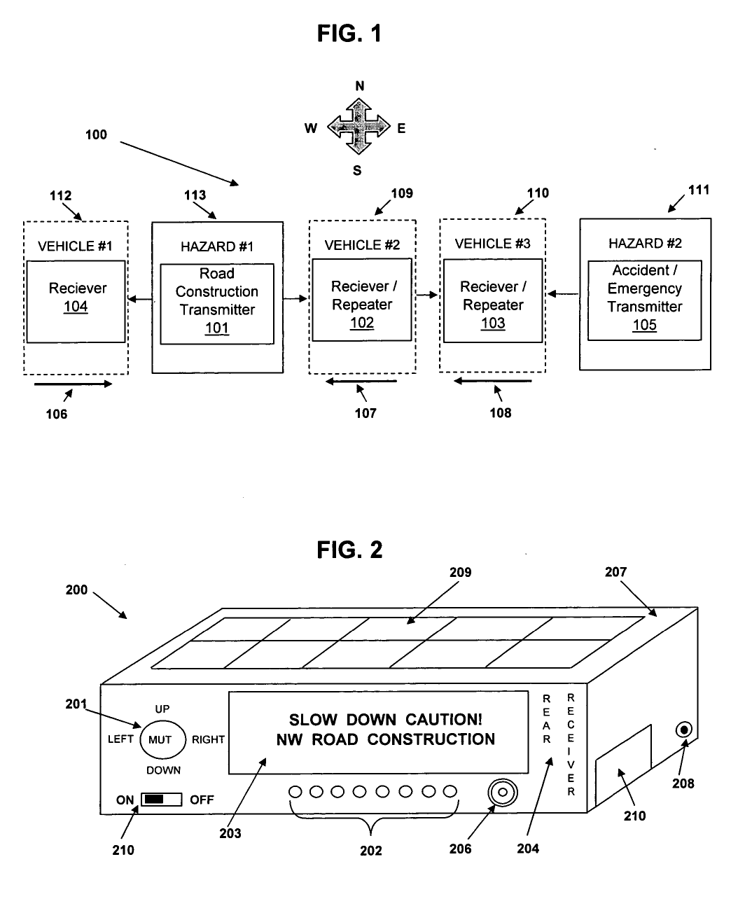

FIG. 1 illustrates a block diagram of a vehicle warning system according to one embodiment of the invention. A vehicle warning system, illustrated generally at 100, is provided for various types of hazardous driving conditions to alert a vehicle operator that a driving hazard is going to be encountered. A warning can be sent from various types of authorized parties to alert the general public of an upcoming driving hazard. For example, a warning may be sent for or by a law enforcement vehicle, an emergency vehicle such as an ambulance or fire truck, a road construction crew, a school bus, a chemical clean up crew, a hazardous material crew, and/or a survey crew. Various other warning signals for hazardous conditions may also be provided such warnings for a train crossing, a bridge having an icy condition or high water level condition, various other weather conditions that may be hazardous such as fog, heavy rain, snow, ice, high winds, etc. Warning signals may be initiated either locally, through a remote activation (i.e. wirelessly), or by automatic detection of that a specific condition exists. In this manner, a vehicle operator is provided with current and updated information throughout their travels.

System 100 illustrates one example of a warning system and includes a first transmitter 113 including a road construction transmitter 101 operably associated with transmitting a warning signal to alert of road construction and a second transmitter 111 including an accident/emergency transmitter 105 operably association with transmitting a warning signal for an accident or emergency. System 100 further includes at least one receiver operable to receive a warning signal such as a first receiver 104 operably associated with a first vehicle 112, a second receiver/repeater 102 operably associated with a second vehicle 109, and a third vehicle receiver/repeater 103 operable associated with a third vehicle 110. First transmitter 113 and second transmitter 111 are configured to be sold exclusively to law enforcement agencies, department of public safety agencies or other traffic related government institutions, contractors, etc. Each transmitter may be fitted within an authorized vehicle or may be provided as a unit and includes an FCC licensed transmitter with an omni or bi-directional transmission antenna. Each transmitter would be configured as a localized transmitter having a range of less than one mile and in some embodiments having a transmission range of one eight (⅛^{th}) mile.

During use, an impending road hazard or hazardous driving condition is determined and first transmitter 113 and/or second transmitter 111 is manually or automatically activated to transmit a warning signal. First transmitter 113 and second transmitter 111 transmit a low-power radio frequency warning signal over one or more radio frequencies with a range of less than approximately one mile. For example, first transmitter 113 may be configured to communicate a warning signal over a distance of approximately one quarter of a mile to reduce interference that may occur with other hazardous condition transmitters such as second transmitter 111 thereby reducing any interference or conflicts that may occur. First receiver 104, second receiver/repeater 102 and third receiver/repeater 103 may then detect a transmitted signal upon a vehicle being within range and alert a vehicle operator of an upcoming hazardous driving condition.

In one embodiment, first transmitter 113 and/or second transmitter 111 may be provided to communicate a warning signal over various frequencies and formats that may be reserved by national or federal organizations that regulate radio frequency communications. For example, a range of frequencies may be reserved for identifying plural hazardous driving conditions. As such, a first hazardous condition may be associated with a first frequency, a second hazardous condition may be associated with a second frequency, a third hazardous condition may be associated with a third frequency, etc. In this manner, first receiver 104, second receiver/repeater 102 and/or third receiver/repeater 103 may be operable to scan plural frequencies and upon detecting one or more of the frequencies being transmitted, provide a warning to a vehicle operator.

In another embodiment, first transmitter 113 and/or second transmitter 111 may be operable to communicate a warning signal over a single radio frequency. For example, a single frequency may be used to output a warning signal to alert of an upcoming hazardous driving condition and as such, first receiver 104, second receiver/repeater 102 and/or third receiver/repeater 103 thereby providing for a simplified implementation of vehicle warning system 100.

In another embodiment, a single frequency may be used to communicate a warning signal having a message identifying a hazardous driving condition. For example, first transmitter 113 may be configured to output a warning signal including a message having an identifier that includes a reference to upcoming road construction. Similarly, second transmitter 105 may be configured to output a warning signal including a message having an identifier that includes a reference to an upcoming accident or emergency driving condition. Each message may be transmitted in a similar manner to paging or messaging systems and may be operable to periodically transmit warning signals, pages, or messages using a low-power radio frequency transmitter to notify a vehicle operator of an upcoming hazardous driving condition. In this manner, a limited frequency range may be required thereby reducing the need for a wide range or band of frequencies that will need to be monitored by each receiver for detecting an upcoming hazardous driving condition. Additionally, messaging or paging based communications may be employed for communicating warning signals from a specific hazard. In this manner, a paging or messaging communication system may communicate a single page (i.e. global page) that may be received by multiple parties or receivers.

In one embodiment, when first vehicle 112 is traveling in an eastbound direction 106 and toward first transmitter 113 and second transmitter 111, first receiver 104 may receive only a warning signal transmitted by first transmitter 113. However, first receiver 104 may also receive both signals provided that first vehicle 112 is within range of receiving both warning signals. As such, an operator may be warned of one or both hazardous driving conditions.

In another embodiment, second vehicle 109 may be traveling in a westbound direction 107 and may be within range to receive both warning signals but may only display a warning for warning signal transmitted by first transmitter 1113. For example, as second vehicle 109 travels away from second transmitter 111, the strength of the signal transmitted by second transmitter 111 becomes weaker. As such, receiver/repeater 102 may differentiate that second vehicle 109 is moving away from second transmitter and omit displaying of a warning. However, second vehicle 109 having a receiver/repeater 102 may communicate a warning signal for second transmitter 11. In this manner, first receiver 104 and third receiver/repeater 103 may receive the both warning signals.

In one embodiment, vehicle warning system 100 may be operable to communicate advertisement messages, accident messages, special event messages or other types of messages that may have an impact on driving conditions. For example, vehicle warning system 100 may be operable to enable a vehicle operator to warn or communicate warning signals to other vehicle operators through communicating messages that may be encoded with specific types of messages. For example, operator of first vehicle 112 may key in or enter a message that may be communicated to second vehicle 109 to alert second vehicle of a hazardous driving condition. A message may be encoded in various ways. In one form, a user may assign a priority to a message and a message may be encoded such that only a targeted audience may be able to receive a message. In another form, a global or public message may be transmitted to warn other drivers of hazardous driving conditions, traffic congestion, vehicle accidents, road hazards, etc. In a further form, a company hosting an event or company affiliated with hosting an event may communicate an event message to vehicle operators notifying vehicle operators of a special event. In this manner, vehicle warning system 100 may be operable to receive various types of messages associated with operating a vehicle.

For example, first vehicle 112 may alert other drivers of a vehicle accident that occurred at a specific exit to a freeway and as such may communicate a global message that includes a textual description such “Accident at exit”, an exit number, such as “20”, a length of time to communicate the message, such as “10” and the number of times a message should be repeated through additional vehicles, such as “60”. In this manner, a message may be encoded to be broadcast and received by any vehicle having a system operable to receive a public broadcast message. In one embodiment, global or public messages may be limited to repeating through less than 100 vehicles. Other limits may also be placed on the number of times a message may be repeated.

In another embodiment, a private message may be communicated by a vehicle operator. For example, operator of first vehicle 112 may determine that an operator of second vehicle 109 is in need of road-side assistance (i.e. flat tire, out of gas, car broke down, etc.). As such, a user may encode a road-side assistance message that may only be received by authorized receivers such as emergency vehicles receivers, police receivers, towing service receivers, etc. A user may select or enter a message such as “Assistance needed”, an exit number, such as “15”, a time to encounter the exit, such as “20” minutes. This type of message may be set up to repeat through 100 vehicles such that a proper recipient may be alerted.

In a further embodiment, special event and/or advertisement messages may be communicated to a vehicle operator using an authorized event messaging transmitter. For example, a message indicating that a special event may be occurring may be communicated to a vehicle operator upon passing a predetermined location. For example, if a vehicle operator were to pass an event center, sporting complex or building, convention center, etc. a message describing a specific event may be communicated and received by a vehicle operator. Such events may occurring that day or may be occurring in the near future. As such, a vehicle transmitter/receiver may stored within a receiver, display an event at a later time to a users to remind a user of an event.

In another embodiment, advertisements for a current event may be communicated to a user and displayed by a receiver. For example, if a user is in route to a baseball game, a message for event parking may be broadcast to a user to inform the user which exit to take for parking. In this manner, as one or more parking lots become full, a message may be communicated to a vehicle operator as to where parking is available and which exit to take to access available parking

In a further embodiment, a user may encounter a ‘grid-lock’ situation or a slow traveling condition. A user or vehicle operator having knowledge of a driving condition, such as an automobile accident, road construction, closed freeway, etc. may communicate or transmit a message as to the approximate exit of the condition. In this manner, a vehicle operator may transmit a message indicating what the condition is and other vehicle operators may adjust their driving route accordingly. For example, a vehicle operator may key in “Road Construction”, and exit number such as “20”, and the length of time to transmit, such as “20” minutes. In this manner, a second user may receive a message that “Road Construction at Exit 20” is ahead and adjust their driving route accordingly.

In another embodiment, a repeater within a vehicle may be used to communicate information to another vehicle having a receiver operable to receive a message from an originating vehicle. For example, vehicle-to-vehicle messaging may be used between parties having a receiver/repeater operable to enable communication of messages. For example, when second vehicle 109 having receiver/repeater 102 passes third vehicle 110 having receiver/repeater 103 operable to communicate with receiver/repeater 102, various types of information may be exchanged between second vehicle 109 and third vehicle 110. For example, a vehicle operator or passenger within second vehicle 109 may enter or author a message using receiver/repeater 102 (not expressly shown) and transmit the message using receiver/repeater 102. In this manner, receiver/repeater 102 may be used as a transmitter to transmit messages allowing an individual to chat, text message, etc. with a vehicle operable to receive a message. For example, an individual may want to determine if a driver of another vehicle would like to correspond without actually knowing the individual. In this manner, a person who's marital status is single may communicate with another person in a social context. In another embodiment, vehicle-to-vehicle communication using a vehicle's transmitter may allow for an individual to inform a stranger of various types of information such as road hazards, if a vehicle has been damaged, if a vehicle has a flat tire, if a vehicle has turn signal accidentally illuminated, if a vehicle's high beam headlights are on, or any other type of condition or information that may be usefully communicated between vehicles. In this manner, a vehicle-to-vehicle communication network may be established between vehicles to further enhance driving conditions.

FIG. 2 illustrates a device for detecting hazardous driving conditions according to one embodiment of the invention. A hazardous driving condition receiver, illustrated generally as receiver 200, includes an input controller 201 operable to scroll textual information displayed within a display 203 and mute an audio or warning signal being output by a speaker 206. Display 203 includes a two-line grayscale liquid crystal display (LCD) elements operable to display up to twenty (20) characters. However, in other embodiments, display may include other types or combinations of displays or display elements such as color displays, color LCD's, thin film transistors (TFTs) displays, organic light emitting diode's (OLEDs) having higher resolution and various colors and the like.

Receiver 200 further includes a series of illuminators 202 operable to indicate the strength of a signal being received by receiver 200. Receiver 200 also includes a rear receiver indicator 204 that may be illuminated when a hazardous condition is detected from behind a vehicle. For example, an emergency vehicle may be approaching from the rear and rear receiver indicator 204 may be illuminated. Electronics for receiver 200 are contained within housing 207 and a power receptacle 208 is provided to enable coupling to an external power source such as a twelve-volt power source (not expressly shown) associated with a vehicle. For example, power receptacle 208 may be adapted to interface with a vehicle's electrical system or may include a removable charge adapter that may be coupled to a twelve-volt charge receptacle of a vehicle.

In one embodiment, batteries (not expressly shown) may be provided within housing 207 and accessed using battery access panel 210. For example, rechargeable or non-rechargeable DC batteries such as AA, AAA, etc. may be employed. Other direct current battery sizes may also be considered. Power receptacle 208 may be used to provide charging for rechargeable batteries if used and may be connected to an external power source operable to provide power sufficient to recharge rechargeable batteries. In another embodiment, receiver 200 may include a solar panel 207 coupled to or integrated as a part of housing 207 and operable to convert solar energy into electrical energy sufficient to power receiver 200 and/or charge rechargeable batteries as needed. Electronics within housing 207 may include a regulator (not expressly shown) to regulate energy produced by solar panel 209.

In one embodiment, housing 207 may be formed of a durable plastic material such as a high-impact, thermally resistant, water resistant, and color retaining plastic material and formed generally as a rectangular-shaped housing sized similar to a hand held or portable electronic device. For example, housing 207 may be formed to include a width of approximately three (3) to four (4) inches, a length of approximately three (2) to three (3) inches, and a width or thickness of approximately one-quarter (¼) inch. Housing 207 may be formed using one or more plastic manufacturing processes. For example, a plastic manufacturing process of injection molding or blow molding may used to form housing 207. Injection molding is a process that is used in mass production of materials and include melted plastic being forcefully injected into a relatively cool mold. As the plastic material hardens, it takes on the shape of the mold cavity. One skilled in the art can appreciate that other methods of forming housing 207 may also be used either alone or in combination with the methods described above. Additionally, other shapes and dimensions may be selected for forming housing 207 as desired.

Receiver 200 further includes a power switch 210 operably coupled to a power source (not expressly shown) such as one or more batteries, a vehicle's power supply, converted solar energy, and/or rechargeable/replaceable batteries. A charge adapter (not expressly shown) may also be provided as a part of receiver 200 that allows for a power source to be converted into a usable direct current power for powering receiver 200. A charge adapter may be provided internal or external to housing 207.

A vehicle operator may mount receiver 200 towards the front of a vehicle to allow for ease of access and viewable without distracting a user's ability to operate a vehicle. Receiver 200 may be integrated as a part of a vehicle's console and may be offered as a standard and/or optional feature of a vehicle. However, in other embodiments, receiver 200 may be mounted on the dashboard of a vehicle, along a rear view mirror of a vehicle, coupled to a windshield of a vehicle, or placed in any location such that a vehicle operator may be alerted of a hazardous driving condition. In one embodiment, receiver 200 may be mounted using a hook and loop material such as VELCRO®, double backed tape, or suction cups sized sufficiently to mount receiver 200.

During operation, receiver 200 receives one or more warning signals transmitted by an authorized low-power radio frequency transmitter. Receiver 200 may be preprogrammed to detect warning signals having a unique identification to determine an upcoming driving hazard that may be encountered by a vehicle operator. For example, a warning signal may include a message similar to an RF signal communicated via a paging or messaging service and may be received by receiver 200 and processed to display a specific warning message associated with the received warning signal. For example, a page or message may include an identifier, such as a number or series of characters which may be resolved to display a warning message within display 203. Various types of messages may be displayed including hazardous driving conditions, traffic or accident information, event information, advertisement information, emergency information, or any other type of information that may effect a driving condition. For example, a second receiver (not expressly shown) may enter and communicate a message such as “Debris in Road at Exit 10”, “Accident at Exit 20”, “Freeway Closed at Exit 210”, “Baseball Game at Exit 112”, “Event Parking at Exit 313”, “Parade at Exit 300 Next Monday”, “Railroad Crossing in 2 Miles”, or any other type of message relating to a driving condition that may be useful to a vehicle operator.

Additionally, an audio alert may be output via speaker 206 to alarm a driver that a hazardous driving condition may be encountered. In one embodiment, receiver 200 may include an audio output jack (not expressly shown) to couple receiver 200 to a vehicle's sound system and provide an audio output when a warning signal is received. In one embodiment, a vehicle operator may mute an audio output through activating or pushing input controller 201.

Receiver 200 upon detecting a warning signal illuminates some or all of illuminators 202 to indicate how close a vehicle may be to a road hazard. For example, upon initially detecting a warning signal, receiver 200 may only illuminate one or two illuminators 202 and as a vehicle approaches a hazardous driving condition, the overall signal strength of a warning signal increases and additional illuminators within a series of illuminators 202 may be illuminated. Similarly, as a vehicle moves away from a hazard, illuminators 202 may be extinguished as the strength of a warning signal weakens. However, in some embodiments, a warning signal may only be communicated in omni-directional manner and as a vehicle passes a transmitter or the driving hazard, illuminators 202 may all extinguish for lack of detecting the warning signal.

In one embodiment, audio tones may be programmed based on a type of hazardous driving condition. For example, a warning tone for a warning signal communicated in association with an emergency vehicle or automobile accident may be different from a warning tone for upcoming road construction. In this manner, a vehicle operator need not view display 203 to identify what type of hazardous driving condition will soon be encountered.

In one embodiment, receiver 200 may detect multiple warning signals. For example, if a first warning signal is provided for a hazardous driving condition, such as ice present over a bridge, and a second warning signal is for an accident that occurred on the other side of the bridge, receiver 200 may process both warning signals and provide an alert. For example, receiver 200 may display the closest hazardous driving condition first (i.e. strongest signal) and would thus display a message that an icy road condition is upcoming. However, in another embodiment, receiver 200 may process both warning signals and prioritize each signal and display the highest priority warning signal. Such priority information may also be provided in addition to and/or part of a message or page transmitted by a hazardous driving condition transmitter. Receiver 200 may also discern which warning signal is most important based on the source of the warning signal. Other methods of prioritizing signals may also be used.

In another embodiment, receiver 200 may receive signals broadcast by a national weather or safety service, such as the National Oceanic and Atmospheric Administration's (NOAA's) National Weather Service and provide an audio output using speaker 206. For example, a receiver 200 may be configured to receive an RF broadcast signal over one or more frequencies having weather or traffic information and may output up-to-date weather or traffic information via speaker 206. A user that desires to listen for current weather or traffic updates may control the volume of a broadcast signal using controller 201 by rotating controller 201 left or right, or muting the audio output by depressing controller 201. In this manner, a vehicle operator may be informed of various hazardous driving conditions that may be encountered while operating a vehicle.

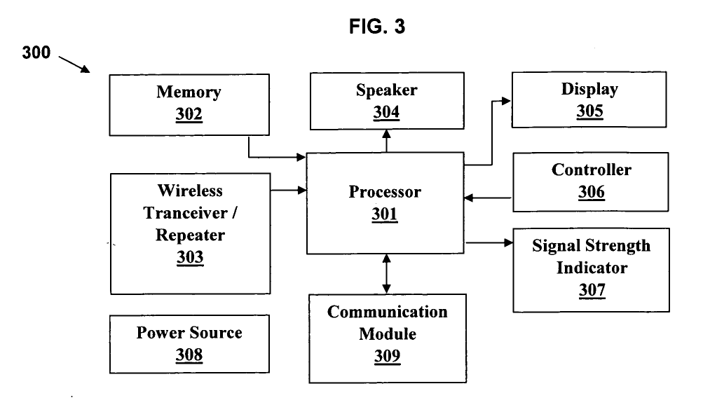

FIG. 3 illustrates a functional block diagram of a device for detecting hazardous driving conditions according to one embodiment of the invention. A device for alerting a driver of a hazardous driving condition, illustrated generally as receiver 300, includes a processor 301 operable as a controller for controlling and processing data or inputs received by receiver 300. Processor 301 may include a microprocessor or microcontroller for controlling and processing data. For example, a single-chip microcomputer with on-board program read only memory (ROM) and input/output (I/O) can be programmed for various control functions and may be provided as a single chip or electronic circuit that includes all or most of the parts needed for a controller including a CPU (central processing unit), RAM (Random Access Memory), EPROM/PROM/ROM (Erasable Programmable Read Only Memory), I/O (input/output)—serial and parallel timers and an interrupt controller. Providing features specific to a task (control) ensuring cost is relatively low. A typical microcontroller has bit manipulation instructions, easy and direct access to I/O (input/output), and quick and efficient interrupt processing. Processor 301 may further include a digital signal processor or a DSP configured processor operable to process signals received by receiver 300.

Receiver 300 further includes a display 305 operable to display a string of alphanumeric characters using one or more types of display types such as liquid crystal diodes (LCDs), light emitting diodes (LEDs), thick film transistor (TFT) displays, and the like. An input controller 306 is provided to access contents displayed by display 305 or to mute or silence an audio output of speaker 304. Memory 302 may include RAM, ROM, EPROM, EEPROM, Flash Memory, or other types of memory and/or programmable memory as needed. A signal strength indicator 307 includes a series of illuminators for indicating the strength of a signal received by wireless transceiver/repeater 303. Wireless transceiver/repeater 303 may include a single receiver operable to receive a single frequency and/or a variable receiver operable to scan plural frequencies to detect warning signals. In one embodiment, wireless transceiver/repeater 303 may be operable to receive messages or pages in association with or as a warning signal. In another embodiment, wireless transceiver/repeater 303 may be operable to transmit a signal received by wireless transceiver/repeater 303 thereby repeating the signal and extending the overall range for communicating a warning signal. For example, wireless transceiver/repeater 303 may communicate a wireless signal similar or substantially similar to the received warning signal sufficient to allow a second receiver (not expressly shown) to receive a communicated wireless signal or warning signal.

Display module 305 includes logic for enabling display of alphanumeric characters. Power source 308 provides power to each component of receiver 300 and may include one or more power buses provided through various voltage regulators, converters, etc. and distributing power to components as needed. For example, in one embodiment a single voltage level (i.e. 1.5 Volts) may be used by all components illustrated in FIG. 3 however in other embodiments, various levels such as 0.5 Volts, 1.5 Volts and 3.3 Volts may be used depending on the type of component(s) used by receiver 300. Additionally, power source 308 may include a battery source, solar energy source, external power source, etc. sufficient to provide power to receiver 300.

Receiver 300 may also include a communication bus (not expressly shown) for communicating data or information between components. For example, processor 301 may request information stored at a specific location within memory 302 and as such a request for information may be processed by a memory controller of memory 302. Contents of the memory location may be placed on a communication bus for use by other components of receiver 300. For example, display module 305 may read data provided on a communication bus for displaying data read from memory 302. Communication buses and operations thereof are well known in the art.

During operation, processor 301 initializes receiver 300 and ensures that each component is functioning properly. For example, processor 301 may include an initialization sequence or routine that is used to initialize each electronic component of receiver 300 to determine an operating or functional status of each component. Such initialization routine may include receiving a predetermined voltage level at an input port (not expressly shown) of processor 31 in response to initializing each component. Other types of initialization routines may also be employed.

Upon providing power and initializing components, receiver 300 may scan one or more frequencies to detect if a warning signal has been communicated by a low-power radio frequency transmitter associated with a road hazard. For example, receiver 300 may scan a single frequency and upon detection of the signal, convert the signal using processor 301 to determine a warning associated with the received signal. Processor 301 may access memory 302 to locate one or more codes associated with the received signal to display a message via display 305 to provide a user a visual indication of a hazardous driving condition. Processor 301 may further determine an audio signal to be output by speaker 304 however in other embodiments a single audio output may be produced for all warnings.

Wireless transceiver/repeater 303 further determines the strength of the received warning signal and communicates to processor 301 a value associated with signal strength to processor 301. Processor 301 determines how many lights to illuminate based on the value of the signal strength and provides an input to signal strength indicator 307 sufficient to illuminate a desired number of illuminators. For example, processor 301 may provide a voltage level to signal strength indicator 307 that may be differentiated by signal strength indicator 307 to illuminate a specific number of illuminators. However, in other embodiments, processor 301 may provide plural output signals to plural illuminators within signal strength indicator 307 to illuminate a specific number of illuminators. Other embodiments may also be employed to provide a visual indication as to the signal strength of a warning signal received by wireless transceiver/repeater 303.

In one embodiment, wireless transceiver/repeater 303 may also transmit or output a wireless signal having the same or substantially characteristics than the received warning signal. For example, a warning signal is received having a specific frequency, wireless transceiver/repeater 303 would in turn communicate the same signal over the same frequency at a specific output level. As such, a user may not be able to modify the output signal such that receiver 300 may be provided as a low power radio frequency transmitter that repeats the same signal(s) communicated by an authorized transmitting party thereby extending the overall range of the authorized transmitting party.

In one embodiment, receiver 300 may scan plural frequencies to determine if a warning signal has been transmitted and provide an output based on a detected signal on a specific frequency. For example, wireless transceiver/repeater 303 may scan up to ten or more frequencies wherein each frequency may be reserved for a specific type of warning of a hazardous driving condition. In this manner, receiver 300 need only detect the presence of one or more signals and in one embodiment, locate an output warning to be displayed based on the frequency of the signal detected. As such, plural frequencies may be scanned and an associated warning displayed within display 305 without having to process the contents of the received wireless signal to extract a warning code, message, page, etc. communicated within a warning signal.

In another embodiment, receiver 300 may receive software updates using one or more types of communication mediums. For example, communication module 309 may include a wireless communication module (i.e. cellular, Bluetooth, Infrared, etc.) and/or a wireline communication module (i.e. Universal Serial Bus (USB), Firewire®, Network Interface Module, etc.) operable to communicate information to receiver 300 to provide a software update to receiver 300. In another embodiment, wireless transceiver/repeater 303 may also be operable to receive software updates via a cellular network or through use of a portion of a frequency band provided by a national broadcast service such as the NOAA. In this manner, various communication mediums may be used to provide software updates to receiver 300 without having to return receiver 300 to a service provider or service center to receive a software update.

Note that although an embodiment of the invention has been shown and described in detail herein, along with certain variants thereof, many other varied embodiments that incorporate the teachings of the invention may be easily constructed by those skilled in the art. Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. Accordingly, the invention is not intended to be limited to the specific form set forth herein, but on the contrary, it is intended to cover such alternatives, modifications, and equivalents, as can be reasonably included within the spirit and scope of the invention.

What is claimed is:

1. An apparatus for detecting a hazardous driving condition comprising:
a short-range radio frequency communication module mountable within an interior portion of a vehicle and operable to receive a warning signal transmitted from an authorized road hazard transmitter, the warning signal identifying a hazardous driving condition; and
a display operable to provide a visual indication representing the received warning signal to alert an individual of the hazardous driving condition.

2. The apparatus as recited in claim 1 further comprising the short-range radio frequency communication module including a repeater operable to transmit a wireless signal representing the received warning signal to a second short-range radio frequency communication module.

3. The apparatus as recited in claim 2 wherein the wireless signal communicated is approximately the received warning signal.

4. The apparatus as recited in claim 2 wherein the wireless signal is different from the received warning signal.

5. The apparatus as recited in claim 1 wherein the short-range radio frequency communication module scans plural frequencies within a set of frequencies to detect the warning signal.

6. The apparatus as recited in claim 1 wherein the communication module scans a single frequency to receive the wireless signal.

7. The apparatus as recited in claim 1 wherein the display includes a graphical display.

8. The apparatus as recited in claim 7 further comprising a strength indicator operably associated with indicating a signal strength of the received warning signal transmitted no greater than approximately one-quarter of a mile.

9. The apparatus as recited in claim 8 further comprising a series of illuminators arranged to provide a visual indication of the signal strength.

10. The apparatus as recited in claim 1 further comprising an input controller operable to select a direction to receive the warning signal.

11. The apparatus of claim 1 further comprising a rechargeable battery operably associated with providing power.

12. The apparatus as recited in claim 111 further comprising a solar panel operable to provide solar energy.

13. The apparatus as recited in claim 11 further comprising a charge plug operable to be coupled to a 12-volt charge receptacle.

12. A vehicle warning system comprising:
a low-power radio frequency transmitter operable to transmit a warning signal identifying a hazardous driving condition;
a short-range radio frequency receiver mountable within an interior portion of a vehicle and operable to receive a warning signal transmitted from the low-power radio frequency transmitter and display operable to display a visual indication of the warning to alert an individual of the hazardous driving condition.

13. The system as recited in claim 11 further comprising the low-power radio frequency transmitter operable to communicate the warning signal over a warning dependent frequency.

14. The system as recited in claim 11 further comprising the transmitter operable to transmit the warning signal over plural frequencies.

15. The system as recited in claim 14 further comprising the short-range radio frequency receiver operable to receive plural warning signals and to display at least one message in response to one of the received signals based on a strength of one of the warning signals.

16. The system as recited in claim 15 wherein the short-range radio frequency receiver comprises a direction selector operable to enable a user to select a direction of one of the received plural warning signals.

17. The system as recited in claim 12 wherein the short-range radio frequency receiver includes a repeater operable to transmit a representation of the received signal.

18. The system as recited in claim 17 wherein the warning signal is transmitted no greater than approximately one quarter of one mile.

19. An apparatus for detecting a hazardous driving condition comprising:
a low power radio frequency transceiver operable to detect communication of a warning signal communicated within less than a one mile radius; and
a display operable to display visual information indicating a type of road hazard associated with the warning signal that may be encountered within the one mile radius.

20. The apparatus of claim 19 further comprising:
communication means for receiving and transmitting plural warning signals;
output means for alerting an individual of an upcoming hazard; and
input means for selecting one of the plural warning signals.
